(19) United States
(12) Patent Application Publication
(10) Pub. No.: US 2006/0085954 A1
(43) Pub. Date: Apr. 27, 2006

(54) Structure bolt snap

(76) Inventor: Ching-Sung Chen, Chang Hua City (TW)

Correspondence Address: RABIN & BERDO, P.C., Suite 500, 1101 14th Street, N.W., Washington, DC, 20005, US

(21) Appl. No.: 10/984,941

(22) Filed: Nov. 10, 2004

(30) Foreign Application Priority Data
Oct. 27, 2004 (TW) 93217040

(51) Int. Cl. F16B 45/04

(52) U.S. Cl. 24/265 H

(57) ABSTRACT

An improved structure bolt snap in which a rounded annular groove is disposed around the bolt body of a retaining body between the protruding ring and the stop ring, a vertical hollow passage and two horizontal through-holes are fabricated in a swivel component, and the lowest end of the slide slot cut contiguously along the bore of the retaining body is of an arcuate shape. As such, after the rounded annular groove and the stop ring of the retaining body are admitted into the hollow passage of the swivel component, two pins are inserted into the through-holes and the rounded annular groove, thereby constrictively conjoining the retaining body and the swivel component to effectively prevent their separation. Additionally, since the lowest end of the slide slot in the retaining body is of an arcuate shape, it is capable of dispersing concentrated stress when pulled by an external force.

### BACKGROUND OF THE INVENTION

1) Field of the Invention

The invention herein relates to an improved structure bolt snap that provides for the inseparable conjoinment of the retaining body and the swivel component and, furthermore, the lowest end of the slide slot of the retaining body is of an arcuate shape to disperse concentrated stress when pulled by an external force.

2) Description of the Prior Art

In contemporary bolt snap retaining bodies, as indicated in FIG. 1-A, the said retaining body A is typically shaped like a question mark and a movable bolt B and a coil spring are disposed inside a bore and, furthermore, a long narrow slide slot A1 is cut contiguously along the bore to provide for the insertion of an actuating member C conjoined to the movable bolt B and a swivel component D is conjoined to the lower end of the retaining body As such, after the retaining body A is insertionally coupled to an object, the swivel component D at the rear is connected to a desired accessory and capable of free rotation to facilitate user convenience; as such, since the coil spring inside the retaining body A bore impels the movable bolt B upward, the movable bolt B remains exposed in the closed state; conversely, when the said actuating member C is manually pressed down, the movable bolt B is shifted downward and compresses the coil spring such that the movable bolt C is the open state. However, when the coupled object E is pulled by an external force (as shown in FIG. 1-B), the path of force is directed towards to the movable bolt B, which is consequently drawn outward, and although the movable bolt B may not break apart, stress is concentrated at the corners A11 defining the bottom section of the long narrow slide slot A1 in the retaining body A, resulting in the development of fissure and fracture damage at the said corners A11 following long-term usage.

In addition, the production process of the said bolt snap consists of first individually fabricating the retaining body A1 and the swivel component D (as shown in FIG. 1-A), wherein an indented section A2 is disposed at the lower extremity of the said retaining body A1 such that a stop ring A3 is formed at the very bottom and the swivel component D has a passageway D1 through it; after the indented section A2 at the lower extremity of the said retaining body A1 is inserted into the passageway D1 of the swivel component D, machining equipment reshapes the two sides of the swivel component D passageway D1 by extrusion, thereby reducing the size of the swivel component D passageway D1, which was originally larger than the stop ring A3, to constrain the retaining body A1 in position on the swivel component D but still allow for circular rotation; however, during initial utilization, since the outer circumference of the stop ring A3 at the very bottom of the retaining body A1 is larger then the inner diameter of the passageway D1 through the swivel component D, operation is totally normal; but when an accessory is insertionally coupled to the swivel component D and regardless of whether the accessory tugs on the swivel component D at a perpendicular or an oblique angle, the result is the continuous abrading of the retaining body A1 stop ring A3 towards swivel component D passageway D1 and, furthermore, given the non-concentric axial relationship of the passageway D1 and the indented section A2 stop ring A3, the passageway D1 gradually enlarges, accelerating the wearing down of the stop ring A3 such that following a period of time, since both are deteriorating, the swivel component D and accessory detach from the retaining body A1 (as shown in FIG. 1-D), the swivel component D and accessory often dropping off unnoticed.

### SUMMARY OF THE INVENTION

In view of the said shortcomings, the applicant of the present invention researched and developed the improved structure bolt snap herein, which is submitted in application for patent rights.

The primary objective of the invention herein is to provide an improved structure bolt snap in which a rounded annular groove is disposed around the bolt body of a retaining body between the protruding ring and the stop ring and, furthermore, a vertical hollow passage and two horizontal through-holes are fabricated in a swivel component; therefore, after the rounded annular groove and stop ring of the retaining body are admitted into the hollow passage of the swivel component, two pins are inserted into the through-holes and the rounded annular groove, thereby constrictively conjoining the retaining body and the swivel component to effectively prevent their separation.

Another objective of the invention herein is to provide an improved structure bolt snap in which the said retaining body has a long narrow slide slot cut contiguously along its bore and the lowest end of the slide slot is of an arcuate shape, the said arcuate shape capable of dispersing concentrated stress due to pulling by an external force.

### BRIEF DESCRIPTION OF THE DRAWINGS

FIG. 1-A is an isometric drawing of the prior art.

FIG. 1-B is an isometric drawing of the prior art when subjected to the pull of an external force.

FIG. 1-C is a cross-sectional drawing of prior art after assembly.

FIG. 1-D is a cross-sectional drawing of the prior art when dislodged.

FIG. 2-A is an exploded drawing of the invention herein.

FIG. 2-B is a cross-sectional drawing of the invention herein.

FIG. 3 is an isometric drawing of the invention herein after assembly.

FIG. 4-A an orthographic drawing of the invention herein after assembly.

FIG. 4-B is a partially magnified drawing of the invention herein following assembly.

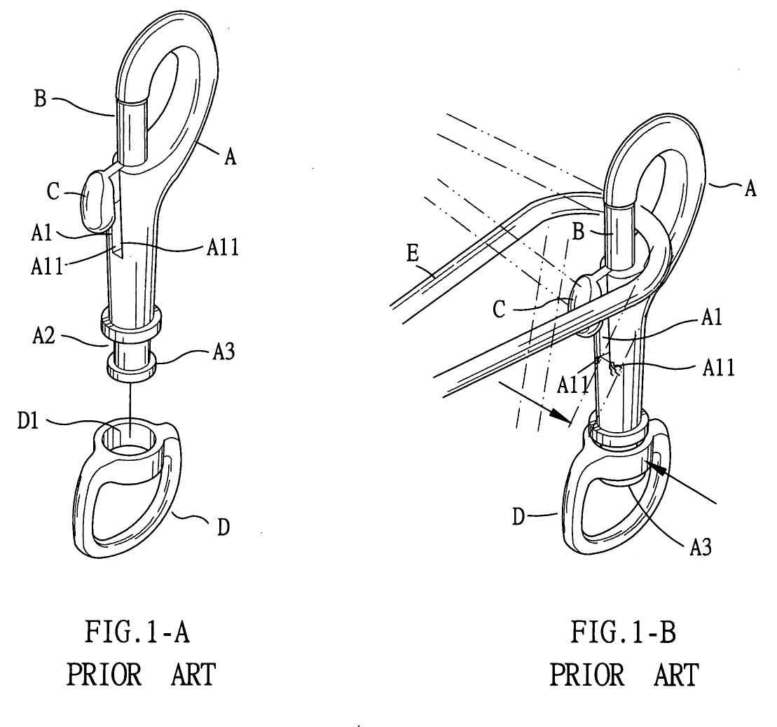

### DETAILED DESCRIPTION OF THE PREFERRED EMBODIMENTS

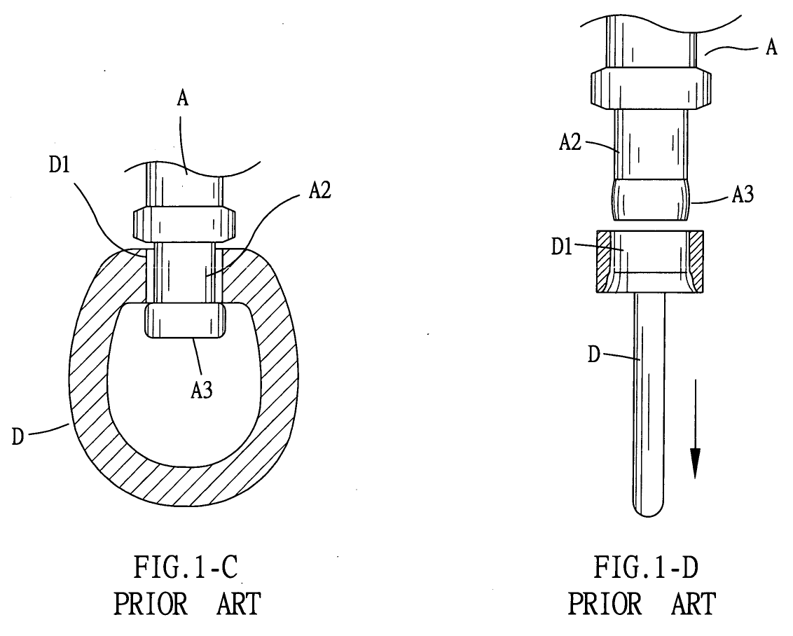

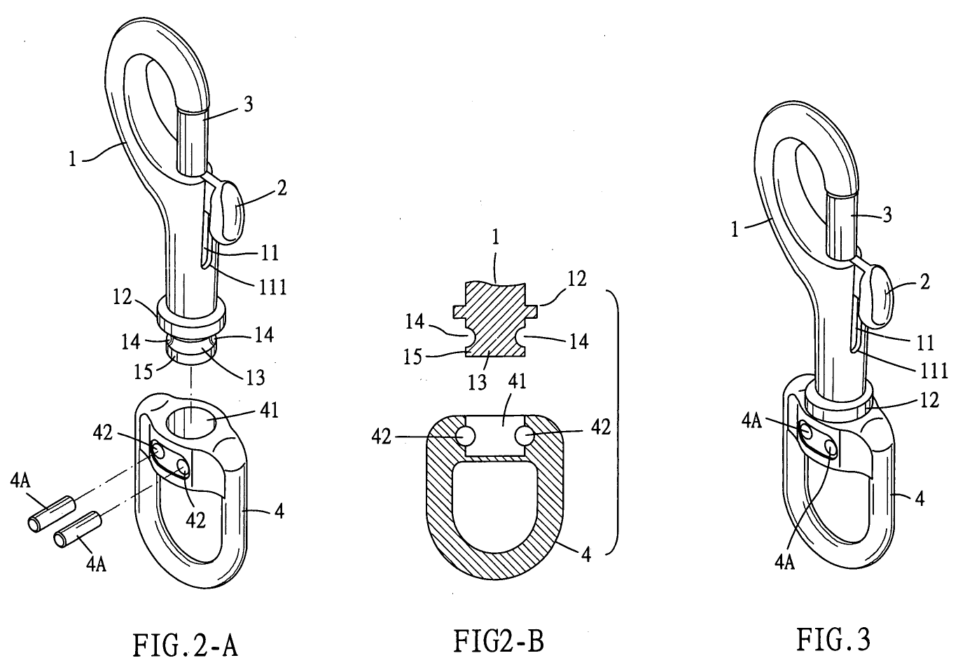

Referring to FIG. 2-A, FIG. 2-B, and FIG. 3, the improved structure bolt snap of the invention herein consists of a retaining body 1 utilized for coupling objects onto handbag straps, key rings, hanging ornament belt clips, pet leashes, industrial-use clip straps, and other large and small items; the said retaining body 1 is shaped like a question mark, a movable bolt 3 and a coil spring are disposed inside its bore and, furthermore, a long narrow slide slot 11 is cut along the bore 11 to provide for the insertion of an actuating member 2 conjoined to the movable bolt 3, wherein the lowest end of the slide slot 11 is of an arcuate shape 111; a protruding ring 12, a bolt body 13, and a stop ring 15 are fabricated at the lower extent of the retaining body 1; a rounded annular groove 14 is disposed around the bolt body 13 between the protruding ring 12 and the stop ring 13, and there is a swivel component 4 having a vertical hollow passage 41 and two horizontal through-holes 42, wherein the said hollow passage 41 and two horizontal through-holes 42 are in contiguity.

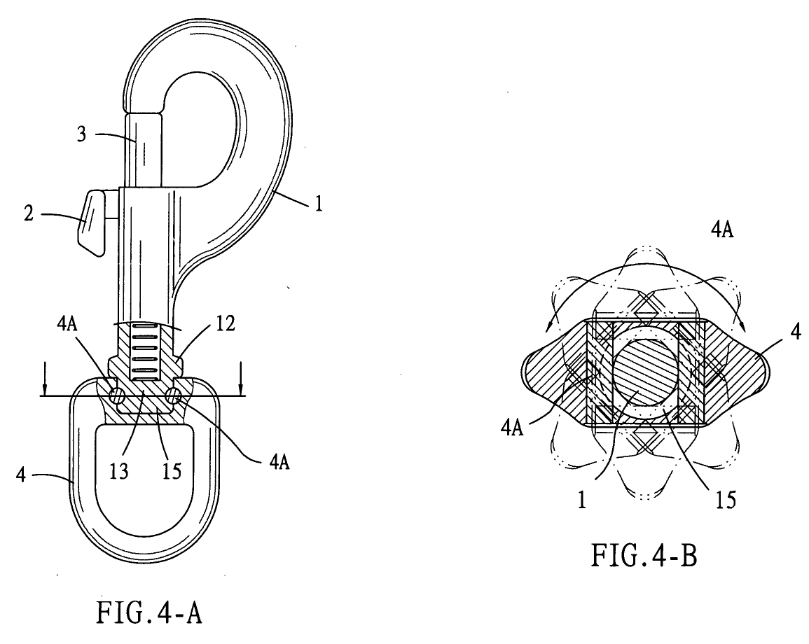

The retaining body 1 stop ring 13 and bolt body 13 are admitted into the swivel component 4 hollow passage 41, two pins 4A are inserted into the through-holes 42 and thereby also nested in the rounded annular groove 14 around the bolt body 13 (as shown in FIG. 3, FIG. 4-A, and FIG. 4-B) such that the retaining body 1 is inseparable from the swivel component 4 but capable of rotating in place without become dislodged; furthermore, when subjected to the external force of pull from an insertionally coupled object, since the path of force is directed towards the movable bolt 3, the movable bolt 3 is drawn outward and pressed against the long narrow slide slot 11, at which time, due to the arcuate shape 111 at the lowest end of the slide slot 11, the concentrated stress produced by the path of force is dispersed, thereby preventing fissure and fracture damage to the slide slot 11 and effectively protecting the retaining body 1.

In summation of the foregoing section, since the structure of the invention herein demonstrably possesses the claimed effectiveness, the present invention meets new patent application requirements as stipulated in Article 93 of the Patent Law and is submitted to the patent bureau for review and the granting of the commensurate patent rights.

1. An improved structure bolt snap in which a rounded annular groove is disposed around the bolt body of a retaining body between the protruding ring and the stop ring and, furthermore, a vertical hollow passage and two horizontal through-holes are fabricated in a swivel component; as such, after the said rounded annular groove and the said stop ring of the said retaining body are admitted into the said hollow passage of the said swivel component, two pins are inserted into the said through-holes and the said rounded annular groove, thereby constrictively conjoining the said retaining body and the said swivel component to effectively prevent their separation.

2. As mentioned in claim 1 of the improved structure bolt snap invention herein, the said retaining body has a long narrow slide slot cut contiguously along its bore and the lowest end of the said slide slot is of an arcuate shape, the said arcuate shape capable of dispersing concentrated stress when pulled by an external force.
